(19) United States
(12) Patent Application Publication
(10) Pub. No.: US 2025/0172247 A1
(43) Pub. Date: May 29, 2025

(54) CRYOGENIC TANK

(71) Applicant: L'Air Liquide, Société Anonyme pour l'Etude et l'Exploitation des Procédés Georges Claude, Paris (FR)

(72) Inventors: Guillaume PETITPAS, Coublevie (FR); Marius Bouin, Sassenage (FR)

(21) Appl. No.: 18/958,819

(22) Filed: Nov. 25, 2024

(30) Foreign Application Priority Data
Nov. 28, 2023 (FR) 2313163

(51) Int. Cl. F17C 3/00

(52) U.S. Cl. CPC F17C 3/00; F17C 2201/0109; F17C 2203/012; F17C 2203/03; F17C 2203/0629; F17C 2209/22; F17C 2223/0161

(57) ABSTRACT

Cryogenic tank having a structure for holding an inner shell (2) in an outer shell (3), with a first connection (5) between the first end (21) of the inner shell (2) and the first end (31) of the outer shell (3), and a second connection (6) between the second end (22) of the inner shell (2) and the second end (32) of the outer shell (3), the first connection (5) being integrally secured on the one hand to a curved region of the dome (31) of the first end of the outer shell (3) and on the other hand to a curved region of the dome (21) of the first end of the inner shell (2), the second connection (6) being integrally secured on the one hand to a curved region of the dome (32) of the second end of the outer shell (3) and on the other hand to a curved region of the dome (22) of the second end of the inner shell (2).

### CROSS REFERENCE TO RELATED APPLICATIONS

This application claims the benefit of priority under 35 U.S.C. § 119 (a) and (b) to French Patent Application No. 2313163, filed Nov. 28, 2023, the entire contents of which are incorporated herein by reference.

### BACKGROUND

The present invention relates to a cryogenic tank for storing liquefied fluid and to a method for assembling such a tank.

Cryogenic tanks are generally made up of two shells assembled to one another and separated from one another by a space allowing thermal insulation and optionally the creation of a vacuum. The cryogenic fluid is stored in the inner shell. The installation of the supports, in other words the mechanical connection between the outer shell and the inner shell, must fulfil the function of limiting intake of heat by conduction while ensuring the required resistance to the mechanical stress to which the tank will be subjected. It is known practice to produce cryogenic tanks comprising supports, generally made of steel, in the form of a neck (sliding or fixed) and/or tie rods.

These solutions are not suitable for the production of compact cryogenic tanks, in particular because they include significant dead volumes that cannot be used to contain the fluid. Since they have to contain fluids, such as hydrogen, in particular in liquid form, that are particularly sensitive to intake of heat, known solutions prioritize thermal performance over working volume for storage.

### SUMMARY

The present invention aims to effectively overcome the above drawbacks by proposing a cryogenic tank for storing liquefied fluid, comprising an inner shell delimiting a storage volume for liquefied fluid and an outer shell arranged around and spaced apart from the inner shell, the space between said inner and outer shells comprising a thermal insulation, the inner and outer shells extending in a longitudinal direction between two longitudinal ends, the inner and outer shells having, at each longitudinal end, a dome-shaped portion, the tank comprising a structure for holding the inner shell in the outer shell, the holding structure comprising a first mechanical connection between the first longitudinal end of the inner shell and the first longitudinal end of the outer shell, and a second mechanical connection between the second longitudinal end of the inner shell and the second longitudinal end of the outer shell, the first mechanical connection being integrally secured on the one hand to a curved region of the dome of the first end of the outer shell and on the other hand to a curved region of the dome of the first end of the inner shell, the second mechanical connection being integrally secured on the one hand to a curved region of the dome of the second end of the outer shell and on the other hand to a curved region of the dome of the second end of the inner shell.

The invention thus makes it possible to propose a more suitable compact architecture, with reduced dead volumes and an optimized cryogenic fluid storage volume, which overcomes all or some of the drawbacks mentioned above.

The invention may advantageously be applied to fixed or movable cryogenic tanks, in particular semi-trailers for transporting liquefied gas, and on-board cryogenic fuel tanks. The fluids in question are for example helium, hydrogen, methane, natural gas, or any other fluid or mixture of fluids at cryogenic temperatures.

According to one embodiment, each dome-shaped portion has a cross section, in a plane orthogonal to the longitudinal direction, having a width that ranges between a minimum width, at the longitudinal end, and a maximum width, the first mechanical connection being integrally secured to the dome of the first end of the outer shell in a region where the width of the section of the dome of the outer shell is between 50% and 100% of the maximum width, and integrally secured to the dome of the first end of the inner shell in a region where the width of the section of the dome of the inner shell is between 50% and 100% of the maximum width.

According to one embodiment, the second mechanical connection is integrally secured to the second end of the outer shell in a region where the width of the section of the dome of the outer shell is between 50% and 100% of the maximum width, and/or to the second end of the inner shell in a region where the width of the section of the dome of the inner shell is between 50% and 100% of the maximum width.

According to one embodiment, at least one of the mechanical connections is integrally secured to the respective dome of the outer shell in a region where the width of the section of the dome of the outer shell is between 80% and 100% of the maximum width, and/or integrally secured to the respective dome of the inner shell in a region where the width of the section of the dome of the inner shell is between 80% and 100% of the maximum width.

According to one embodiment, at least one of the mechanical connections is integrally secured to the respective dome of the outer shell in a region where the width of the section of the dome of the outer shell is greater than 50% and strictly less than 100% of the maximum width, and/or integrally secured to the respective dome of the inner shell in a region where the width of the section of the dome of the inner shell is greater than 50% and strictly less than 100% of the maximum width.

According to one embodiment, the first mechanical connection is rigidly attached to the outer shell, and attached to the inner shell in such a way that it can move and/or deform in response to a relative expansion and/or contraction of the inner shell.

According to one embodiment, the first and/or the second mechanical connection comprises several bearing structures distributed angularly around a central axis.

According to one embodiment, the bearing structures form part of a connection ring extending around the central axis and delimiting an open volume the section of which, in a plane orthogonal to the central axis, has a monotonic variation when moving along the central axis.

According to one embodiment, the connection ring has an inner face facing the dome of the inner shell and an outer face facing the dome of the outer shell, the inner face having a profile complementary to the profile of the dome of the inner shell.

According to one embodiment, the outer face of the connection ring has a profile complementary to the profile of the dome of the outer shell.

According to one embodiment, the first and/or the second mechanical connection comprises at least three bearing structures, each comprising at least one internal protrusion protruding from the inner face of the connection ring and at least one external protrusion protruding from the outer face of the connection ring, the connection ring being integrally secured to the inner and respectively outer shell only at these protrusions.

According to one embodiment, the bearing structures are uniformly distributed angularly around the central axis.

According to one embodiment, the central axis is parallel or coincident with the longitudinal axis.

According to one embodiment, the open volume delimited by the connection ring has a section of substantially elliptical shape.

According to one embodiment, the open volume delimited by the connection ring has a section of substantially circular shape.

According to one embodiment, the external protrusions are welded or adhesively bonded to the outer shell, and the internal protrusions are welded or adhesively bonded to the inner shell.

According to one embodiment, the holding structure comprises only the first and second mechanical connections.

According to one embodiment, the holding structure comprises at least one third mechanical connection positioned longitudinally, along the longitudinal axis, between the first mechanical connection and the second mechanical connection.

The invention also relates to a method for assembling a tank as described above, the longitudinal axis being horizontal during assembly, comprising the following successive steps
a) attaching the first mechanical connection to the dome of the first end of the inner shell;
b) inserting the assembly thus obtained into the outer shell;
c) attaching the first mechanical connection to the dome of the first end of the outer shell.

The invention also relates to a method for assembling a tank as described above, the longitudinal axis being vertical during assembly, comprising the following successive steps
a) attaching the first mechanical connection to the dome of the first end of the outer shell;
b) inserting the inner shell into the outer shell;
c) attaching the first mechanical connection to the dome of the first end of the inner shell.

### BRIEF DESCRIPTION OF THE DRAWINGS

The invention will be understood more clearly from reading the following description and from studying the accompanying figures. These figures are provided purely by way of illustration and do not in any way limit the invention.

FIG. 1 is a schematic and partial view in vertical and longitudinal section illustrating a first possible embodiment of the invention;

FIG. 2 is a schematic and partial view in section of a detail of any of the longitudinal ends of the inner or outer shell of FIG. 1;

FIG. 3 is a schematic and partial view in section of a detail of a first end of the tank of the embodiment of FIG. 1;

FIG. 4 is a schematic and partial perspective view illustrating an embodiment of the supports of FIG. 1;

FIG. 5 is a schematic and partial view in vertical and longitudinal section illustrating a second possible embodiment of the invention.

### DETAILED DESCRIPTION OF THE PREFERRED EMBODIMENTS

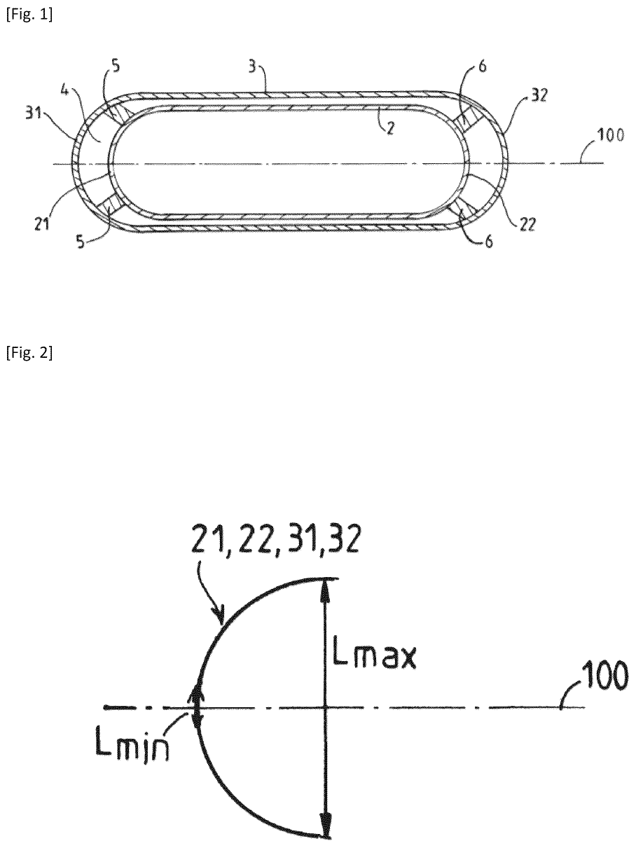

The cryogenic tank 1 shown by way of example in FIG. 1 comprises an inner shell 2 delimiting a storage volume for liquefied fluid and an outer shell 3 arranged around and spaced apart from the inner shell 2. The space between said inner 2 and outer 3 shells comprises a thermal insulation 4. The thermal insulation may notably comprise multi-layer insulation (MLI), perlite, foam, glass beads or any other suitable insulation. The thermal insulation may also be under vacuum, the space between said shells then being placed under vacuum at a pressure below 10⁻² mbar, and preferably between 10⁻⁴ mbar and 10⁻⁷ mbar.

In the example illustrated, the inner 2 and outer 3 shells extend in a longitudinal direction 100 between two longitudinal ends. The inner and outer shells have, at each longitudinal end, a dome-shaped end portion 21, 31, 22, 32. A main body, referred to as the casing, extends between the two longitudinal ends of the tank. The casing is preferably a cylinder of circular section, but alternatively it could have an elliptical section or a section of another shape adapted to the requirements.

Other shapes are also possible for at least one of the end portions 21, 31, 22, 32 of the inner shell 2 and/or of the outer shell 3, for example a cylinder, a parallelepiped or another polyhedron, in particular in the case where a valve box is associated with the tank.

The tank 1 comprises a structure for holding the inner shell 2 in the outer shell 3. The holding structure comprises a first mechanical connection 5 between the first longitudinal end 21 of the inner shell 2 and the first longitudinal end 31 of the outer shell 3, and a second mechanical connection 6 between the second longitudinal end 22 of the inner shell 2 and the second longitudinal end 32 of the outer shell 3. The first mechanical connection 5 is integrally secured, on the one hand, to a curved region of the dome of the first end 31 of the outer shell 3, and, on the other hand, to a curved region of the dome of the first end 21 of the inner shell 2.

The second mechanical connection 6 is integrally secured, on the one hand, to a curved region of the dome of the second end 32 of the outer shell 3 and, on the other hand, to a curved region of the dome of the second end 22 of the inner shell 2.

As shown in FIG. 2, each of the end portions 21, 31, 22, 32 may have a cross section, in a plane orthogonal to the longitudinal axis 100, having a width that ranges between a minimum width, at the longitudinal end, and a maximum width at the junction with the casing. In the case of a cylindrical casing and two dome-shaped ends, the maximum width thus corresponds to the diameter of the casing.

The first mechanical connection 5 may be integrally secured to the dome of the first end 31 of the outer shell 3 in a region where the width of the section of the dome 31 of the outer shell 3 is between 50% and 100% of the maximum width, and preferably between 80% and 100% of the maximum width.

The first mechanical connection 5 may be integrally secured to the dome of the first end 21 of the inner shell 2 in a region where the width of the section of the dome 21 of the inner shell 2 is between 50% and 100% of the maximum width, and preferably between 80% and 100% of the maximum width.

The second mechanical connection 6 may be integrally secured to the second end 32 of the outer shell 3 in a region where the width of the section of the dome 32 of the outer shell 3 is between 50% and 100% of the maximum width, and preferably between 80% and 100% of the maximum width.

The second mechanical connection 6 may be integrally secured to the second end 22 of the inner shell 2 in a region where the width of the section of the dome 22 of the inner shell 2 is between 50% and 100% of the maximum width, and preferably between 80% and 100% of the maximum width.

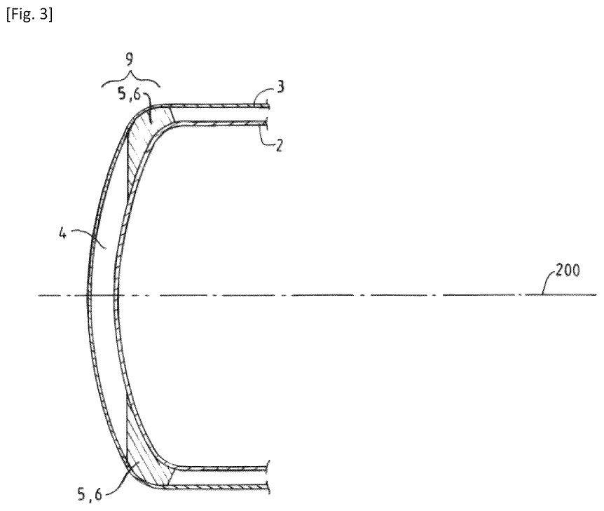

In other words, the mechanical connections 5, 6 are mechanically attached to the dome 31, 32 of the end of the outer shell 3, respectively to the dome 21, 22 of the end of the inner shell 2, in a peripheral area thereof and at least a portion of this attachment is located in a region where the width of the section of the dome 21, 22, 31, 32 is strictly less than the maximum width. Thus, as shown in FIG. 3, the mechanical connection 5, 6 may be integrally secured to the outer shell 3, respectively to the inner shell 2, in a region straddling the dome and the casing.

Such a position of the mechanical connections 5, 6 makes it possible in particular to reduce the size of the space between the inner shell 2 and the outer shell 3, thus making more efficient use of the available volume and reducing the overall bulk of the system. In other words, the ratio between the working volume for containing the cryogenic fluid and the total volume of the tank is higher than for a prior art cryogenic tank. Thus, for example, a tank produced according to the invention and having the same bulk as a prior art tank will have a larger working volume. Alternatively, a tank according to the invention and having the same working volume as a prior art tank will have a smaller overall bulk.

The system is also more resistant to radial forces and stress, while still having a low intake of heat.

Moreover, by shifting the mechanical connections, for example in the form of rings, from the casing to the domes, the thermal insulation of the casing is more efficient and easier to install. Thus, any intake of heat is shifted to the dome.

In other embodiments, all of the mechanical connections 5, 6, or at least some of them, are mechanically attached to the dome 31, 32 of the end of the outer shell 3, respectively to the dome 21, 22 of the end of the inner shell 2, in a peripheral area thereof and the whole of this attachment is located in a region where the width of the section of the dome 21, 22, 31, 32 is strictly less than the maximum width. In this case, the mechanical connections 5, 6 are not in direct contact with the casing and the bulk may be further reduced.

In order to minimize the intake of heat, the mechanical connections 5, 6 are preferably made of a material with a low thermal conductivity, in particular below 1 W m⁻¹ K⁻¹. Examples of suitable materials are glass fibre composites, for example glass fibre-epoxy such as G10 or G11.

The first mechanical connection 5 may be rigidly attached to the outer shell 3 and attached to the inner shell 2 in such a way that it can move and/or deform in response to a relative expansion and/or contraction of the inner shell.

The second mechanical connection 6 may then be rigidly attached both to the outer shell 3 and to the inner shell 2. Preferably, the pipe or pipes for supplying and/or withdrawing fluid are mounted at the second longitudinal end, where the connection 6 is rigidly attached.

Thus, the first mechanical connection 5 constitutes a connection between the two shells 2, 3 that is more deformable (relatively more flexible connection) than the second mechanical connection 6 (relatively more rigid connection). In other words, the first mechanical connection 5 is configured so that, when there is a temperature differential between the two shells 2, 3 generating a relative retraction or expansion of the shells 2, 3, it allows a relative longitudinal movement between the two shells 2, 3 at the first end that is greater than the relative longitudinal movement allowed by the second mechanical connection 6 at the second end.

These relative degrees of flexibility or rigidity may be chosen by adapting the dimensions of the mechanical connections 5, 6 and/or their materials. For example, the more deformable connection may be made of foam or another suitable composite, and the more rigid connection may be made of epoxy.

Compared to steel mechanical connections found in the prior art, this makes it possible to make the system more lightweight, while still holding the inner shell 2 in place inside the outer shell 3 and ensuring optimal resistance to mechanical stress.

Thus, the inner shell 2 may be supported in the outer shell 3 by two mechanical connections 5, 6, one of which is relatively more deformable and configured in particular to deform during the relative contraction of the chilled inner shell 2. This deformation is configured to make it possible to absorb the variations in the relative dimensions of the two shells 2, 3 without impairing the holding of the inner shell in the outer shell 3 and without affecting the thermal insulation. It also makes it possible to prevent the relative contraction of the inner shell from placing excessive mechanical stress on the pipes.

In particular, this architecture allows a deformation of the first mechanical connection 5 that is close to the relative longitudinal contraction of the inner shell 2 (and that allows this contraction of the inner shell 2).

When the inner shell 2 is filled with cryogenic liquid, the thermal gradient (from the outside ambient temperature to the temperature of the cryogenic liquid on the inside: for example between −269° C. and −180° C.) that will be experienced by this first mechanical connection 5 will make it possible to accompany the relative thermal contraction of the inner shell 2 at the first end, whereas the second end (at the second mechanical connection 6, considered a fixed point) will undergo a zero or smaller deformation. During its contraction, the inner shell 2 (at least one end connected to the inner shell 2) will move longitudinally relatively towards the second (relatively fixed) end.

Note that the term “flexible” used above does not necessarily mean that the first mechanical connection 5 is intrinsically “flexible”. On the contrary, this first mechanical connection 5 is configured to deform (longitudinal movement) in response to changes in temperature while making it possible to withstand radial forces. In particular, the first mechanical connection 5 is thus able and configured to maintain sufficient rigidity in the radial (transverse) directions in order to take up forces.

In another embodiment that has not been shown, the first and the second mechanical connections 5, 6 may both be rigidly attached to the outer shell, and attached to the inner shell in such a way that they can move and/or deform in response to a relative expansion and/or contraction of the inner shell. In this case, the pipe or pipes for supplying and/or withdrawing fluid are mounted, preferably, at the end corresponding to the less flexible mechanical connection 5, 6.

The first and/or the second mechanical connection may comprise a plurality of bearing structures 7, 8, for example at least three bearing structures, distributed angularly around a central axis 200. These bearing structures 7, 8 may be separate or form part of a connection ring 9 extending around the central axis 200.

The bearing structures are intended to come into contact with the inner and/or outer shell. They may be welded, adhesively bonded, or connected to the shells 2, 3 by another suitable means. Alternatively, they may be force-fitted and wedged between the shells 2, 3. In all cases, assembly of the tank is simplified. For example, the total surface area for welding or adhesive bonding may be reduced compared to prior art tanks comprising one or two necks.

The bearing structures 7, 8 may each comprise at least one internal protrusion 8 protruding from the inner face of the connection ring and/or at least one external protrusion 7 protruding from the outer face of the connection ring. In this case, the connection ring is integrally secured to the outer 3 and respectively inner 2 shell only at these respective protrusions. The surface of the protrusions 7, 8 that is in contact respectively with the outer shell 3 or the inner shell 2 may have a profile complementary respectively to the surface of the outer shell 3 or of the inner shell 2.

The join between the external protrusions 7 and the outer shell 3, respectively between the internal protrusions 8 and the inner shell 2, may for example be obtained by welding or adhesive bonding. In order to obtain different degrees of flexibility or rigidity, it may be envisaged for the external 7 and internal 8 protrusions to be joined to the respective shell by different technical means. For example, the external protrusions 7 may be welded to the outer shell 3, while the internal protrusions are adhesively bonded to the inner shell 2, or vice versa.

Depending on the level of mechanical stress to be withstood, the thickness of the ring may be modified, being thinner for stress expected to be moderate and thicker when loads are expected to be higher.

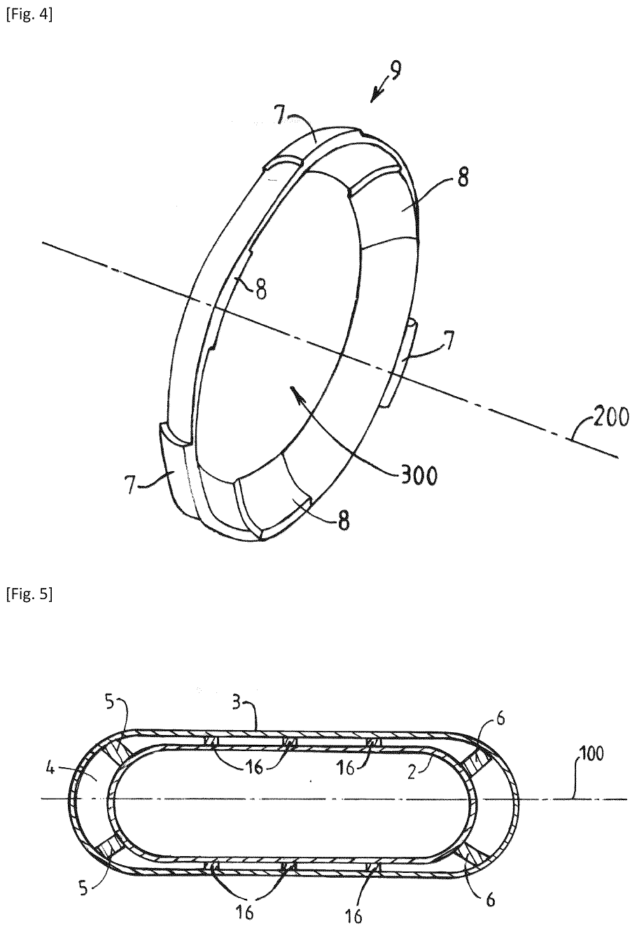

According to the embodiment illustrated in FIG. 4, the connection ring 9 delimits an open volume 300, the section of which, in a plane orthogonal to the central axis 200, has a monotonic variation when moving along the central axis 200. In other words, considering successive sections in successive planes orthogonal to the central axis 200, the surface area of the section of the open volume 300 increases or decreases monotonically depending on whether the direction of movement is respectively from the longitudinal end towards the casing or from the casing towards the longitudinal end. The inner face of the ring 9 in this case has a surface that converges towards the opening of the ring, and the protrusions 7, 8 have a uniform thickness.

Alternatively, the surface of the inner face of the ring 9 may be cylindrical and the protrusions 7, 8 may have a thickness that varies monotonically along the central axis 200. In other words, the inner face of the ring 9 has a surface parallel to the central axis 200 and the protrusions 7, 8 have a profile converging towards the opening of the ring. Likewise, in this case, considering successive sections in successive planes orthogonal to the central axis 200, the surface area of the section of the open volume 300 increases or decreases monotonically depending on whether the direction of movement is respectively from the longitudinal end towards the casing or from the casing towards the longitudinal end.

The inner face of the connection ring 9 may, when the tank is assembled, face the dome of the inner shell 2.

The outer face of the connection ring 9 may, when the tank is assembled, face the dome of the outer shell 3.

The inner face of the connection ring 9 may have a profile complementary to the profile of the dome of the inner shell. For example, the surface of the inner face of the ring 9 may correspond to a homothety of the surface of the inner shell 2.

The outer face of the connection ring 9 may also have a profile complementary to the profile of the dome of the outer shell 3. For example, the surface of the outer face of the ring 9 may correspond to a homothety of the surface of the outer shell 3.

In order to maximize the thermal path between the inner shell and the outer shell and thus reduce thermal losses, the bearing structures are offset and preferably uniformly distributed angularly around the central axis 200. The angular distance between an internal protrusion and an adjacent external protrusion is in particular equal to 360° divided by the total number of internal and external protrusions. To define this distance, the angle having its vertex on the central axis 200 is taken into account.

In another embodiment that has not been shown, for the same mechanical connection 5, 6, the number of internal protrusions 8 may not be equal to the number of external protrusions 7.

The central axis 200 of the connection ring is preferably parallel or coincident with the longitudinal axis 100. The mechanical forces are thus distributed more equally.

The section of the open volume 300 in a plane orthogonal to the central axis 200 has a shape that preferably corresponds to the shape of the section of the inner shell 2. For example, this section of the open volume 300 may be substantially elliptical or circular. The protrusions 7, 8 are not taken into account when defining this shape. Corresponding (or mating) shapes of this section of the open volume 300 of the ring and the section of the inner shell 2 make it possible in particular to facilitate the alignment and assembly of these two elements.

In one possible embodiment of the invention shown in FIG. 1, the holding structure comprises only the first 5 and second 6 mechanical connections, in other words the holding structure is made up of the abovementioned two connections. Alternatively, as shown in FIG. 5, the holding structure may comprise one or more additional mechanical connections 16, for example when the length of the tank is particularly great, or when there is an increased need for mechanical strength. In particular, there may be at least one third mechanical connection 16 positioned longitudinally, along the longitudinal axis 100, between the first mechanical connection 5 and the second mechanical connection 6. Preferably, the distribution of the mechanical connections along the longitudinal axis 100 is uniform, in order to optimize thermal paths and minimize thermal losses. Preferably, the at least one third mechanical connection is of flexible type.

The invention also relates to methods for assembling a tank as described above. As methods for producing the inner shell are already known, the description will be confined to the mounting of the inner shell in the outer shell and the suspension thereof by the first and second mechanical connections.

The inner shell, comprising a dome at each longitudinal end, must be positioned and suspended inside the outer shell. To this end, the outer shell initially only comprises the casing and a dome at one longitudinal end. The dome at the other longitudinal end is assembled later, once the inner shell has been suspended inside the outer shell.

According to a first production method, the longitudinal axis 100 of the tank is horizontal during assembly. The method comprises the following successive steps: attaching the first mechanical connection 5 to the dome of the first end of the inner shell 2; inserting the assembly thus obtained into the outer shell; attaching the first mechanical connection 5 to the dome of the first end of the outer shell 2.

According to a second production method, the longitudinal axis 10 of the tank is vertical during assembly. The method comprises the following successive steps: attaching the first mechanical connection 5 to the dome of the first end of the inner shell 2; inserting the assembly thus obtained into the outer shell; attaching the first mechanical connection 5 to the dome of the first end of the outer shell 2.

The mechanical connections may be attached to the outer shell and to the inner shell, as described above, by any suitable means and in particular by welding or by adhesive bonding.

Thus, a cryogenic tank 1 according to the invention is simpler to manufacture, makes more efficient use of the available volume and optimizes the compromise between absorption of mechanical stress and limiting the intake of heat.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A cryogenic tank for storing liquefied fluid, comprising an inner shell delimiting a storage volume for liquefied fluid and an outer shell arranged around and spaced apart from the inner shell, the space between said inner and outer shells comprising a thermal insulation, the inner and outer shells extending in a longitudinal direction between two longitudinal ends, the inner and outer shells having, at each longitudinal end, a dome-shaped portion, the tank comprising a structure for holding the inner shell in the outer shell, the holding structure comprising a first mechanical connection between the first longitudinal end of the inner shell and the first longitudinal end of the outer shell, and a second mechanical connection between the second longitudinal end of the inner shell and the second longitudinal end of the outer shell, the first mechanical connection being integrally secured on the one hand to a curved region of the dome of the first end of the outer shell and on the other hand to a curved region of the dome of the first end of the inner shell, the second mechanical connection being integrally secured on the one hand to a curved region of the dome of the second end of the outer shell and on the other hand to a curved region of the dome of the second end of the inner shell, each dome-shaped portion having a cross section, in a plane orthogonal to the longitudinal direction, having a width that ranges between a minimum width, at the longitudinal end, and a maximum width, the first mechanical connection being integrally secured to the dome of the first end of the outer shell in a region where the width of the section of the dome of the outer shell is between 50% and 100% of the maximum width, wherein the first mechanical connection is integrally secured to the dome of the first end of the inner shell in a region where the width of the section of the dome of the inner shell is between 50% and 100% of the maximum width, and in that the first and/or the second mechanical connection comprises several bearing structures distributed angularly around a central axis, and in that the bearing structures form part of a connection ring extending around the central axis and delimiting an open volume the section of which, in a plane orthogonal to the central axis, has a monotonic variation when moving along the central axis.

2. The cryogenic tank according to claim 1, wherein the second mechanical connection is integrally secured to the second end of the outer shell in a region where the width of the section of the dome of the outer shell is between 50% and 100% of the maximum width, and/or to the second end of the inner shell in a region where the width of the section of the dome of the inner shell is between 50% and 100% of the maximum width.

3. The cryogenic tank according to claim 2, wherein at least one of the mechanical connections is integrally secured to the respective dome of the outer shell in a region where the width of the section of the dome of the outer shell is greater than 50% and strictly less than 100% of the maximum width, and/or integrally secured to the respective dome of the inner shell in a region where the width of the section of the dome of the inner shell is greater than 50% and strictly less than 100% of the maximum width.

4. The cryogenic tank according to claim 1, wherein the first mechanical connection is rigidly attached to the outer shell and attached to the inner shell in such a way to allow movement and/or deform in response to a relative expansion and/or contraction of the inner shell.

5. The cryogenic tank according to claim 1, wherein the connection ring has an inner face facing the dome of the inner shell and an outer face facing the dome of the outer shell, the inner face having a profile complementary to the profile of the dome of the inner shell, and/or the outer face of the connection ring has a profile complementary to the profile of the dome of the outer shell.

6. The cryogenic tank according to claim 5, wherein the first and/or the second mechanical connection comprises at least three bearing structures, each comprising at least one internal protrusion protruding from the inner face of the connection ring and at least one external protrusion protruding from the outer face of the connection ring, the connection ring being integrally secured to the inner and respectively outer shell only at these protrusions.

7. The cryogenic tank according to claim 1, wherein the bearing structures are uniformly distributed angularly around the central axis.

8. The cryogenic tank according to claim 1, wherein the ring delimits an open volume the section of which, in a plane orthogonal to the central axis, has a monotonic variation when moving along the central axis, the open volume having a section of substantially elliptical or circular shape.

9. The cryogenic tank according to claim 2, wherein the holding structure comprises only the first and second mechanical connections.

10. The cryogenic tank according to claim 1, wherein the holding structure comprises at least one third mechanical connection positioned longitudinally, along the longitudinal axis, between the first mechanical connection and the second mechanical connection.

11. A method for assembling a tank according to claim 1, the longitudinal axis being horizontal during assembly, comprising the following successive steps
a) attaching the first mechanical connection to the dome of the first end of the inner shell;
b) inserting the assembly thus obtained into the outer shell;
C) attaching the first mechanical connection to the dome of the first end of the outer shell.

12. The method for assembling a tank according to claim 1, the longitudinal axis being vertical during assembly, comprising the following successive steps
a) attaching the first mechanical connection to the dome of the first end of the outer shell;
b) inserting the inner shell into the outer shell;
c) attaching the first mechanical connection to the dome of the first end of the inner shell.
